(19) United States
(12) Patent Application Publication
(10) Pub. No.: US 2025/0355825 A1
(43) Pub. Date: Nov. 20, 2025

(54) REMOVABLE AND ELECTRICALLY READABLE ADDRESSING DEVICE IN A BASE UNIT OF AN ADDRESSABLE DEVICE

(71) Applicant: Tyco Fire & Security GmbH, Neuhausen am Rheinfall (CH)

(72) Inventors: Steven Ian BENNETT, Neuhausen am Rheinfall (CH); Robert FELTHAM, Fort Lauderdale, FL (US); Moosa Farook MEAH, Surrey (GB)

(21) Appl. No.: 18/666,525

(22) Filed: May 16, 2024

(51) Int. Cl. G06F 13/40; G06F 13/10

(52) U.S. Cl. CPC G06F 13/4081; G06F 13/102

(57) ABSTRACT

Example implementations include an addressable device having a base unit mountable on a structure and a device head removably mountable onto the base unit. A removable addressing device is removably mountable onto the base unit and comprises at least one memory storing an address for the addressable device. When the device head and the removable addressing device are mounted onto the base unit, the device head is electrically connected with the removable addressing device and is configured to read the address stored on the at least one memory of the removable addressing device.

### FIELD

The present disclosure relates generally to security/automation systems, and more particularly, to addressable devices in security/automation systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes an addressable device comprising a base unit mountable on a structure and a device head removably mountable onto the base unit. A removable addressing device is removably mountable onto the base unit and comprises at least one memory storing an address for the addressable device. When the device head and the removable addressing device are mounted onto the base unit, the device head is electrically connected to the removable addressing device and is configured to read the address stored on the at least one memory of the removable addressing device.

Another example implementation includes a removable addressing device comprising at least one memory storing an address for an addressable device. The removable addressing device is removably mountable onto a base unit of the addressable device. The base unit is mountable on a structure. The addressable device further comprises a device head that is removably mountable onto the base unit. When the device head and the removable addressing device are mounted onto the base unit, the device head is electrically connected to the removable addressing device and is configured to read the address stored on the at least one memory of the removable addressing device.

A further example implementation includes a base unit of an addressable device. The base unit comprises a receiving portion configured for removably mounting a removable addressing device thereonto. The removable addressing device comprises at least one memory storing an address for the addressable device. The base unit is mountable on a structure. A device head of the addressable device is removably mountable onto the base unit. When the device head and the removable addressing device are mounted onto the base unit, the device head is electrically connected to the removable addressing device and is configured to read the address stored on the at least one memory of the removable addressing device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an isometric view of an example addressable device having a base unit configured for mounting a removable addressing device thereon, according to some aspects;

FIG. 2A is a top view of the base unit of FIG. 1, according to some aspects;

FIG. 2B is a top view of the base unit of FIG. 1 with a removable addressing device mounted thereon, according to some aspects;

FIG. 3A is a top view of an example address pennant according to some aspects;

FIG. 3B is a bottom view of an example address pennant according to some aspects;

FIG. 4 is a schematic electric wiring diagram of the example addressable device of FIG. 1, according to some aspects; and

FIG. 5 is a block diagram of an example computing device which may implement all or a portion of an addressable device, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Some present aspects implement a removable and electrically readable addressing device in a base unit onto which a device head of an addressable device of a security/automation system is mounted. The device head, which is powered by electricity, determines the device address by running an electric current through the addressing device to read an address stored on the addressing device in the base unit of the device. If the device head has to be replaced, the device address remains with the base unit, thus no further addressing configurations are needed upon replacement of the device head. Also, since the addressing device is removably implemented in the base unit, an installer may change the device address by removing the addressing device from the base unit, swapping or re-configuring the addressing device, and then plugging the swapped or re-configured addressing device back into the base unit. Some aspects may use a tool (e.g., a device including a software tool) to update the address stored on the addressing device if needed. In some aspects, the removable addressing device may be configured as a removable address pennant, e.g., a card-shaped device which may also visually indicate the address on one or more labels printed thereon.

In some aspects, the device head may include, for example but not limited to, a sensor/detector unit or a notification unit in an emergency alarm system and/or a security/automation system. For example, the device head may include an emergency alarm system peripheral such as a hazard detector (including but not limited to a smoke, heat, carbon monoxide (CO), carbon dioxide (CO2), flame, natural gas, or another toxic or noxious chemical detector, a pull station, etc.), an intrusion detector (including but not limited to window and door contacts, glass break sensors, water or water level sensors, passive infra-red (IR) detectors, cameras, sound sensors, motion detectors, etc.), or a notification appliance (including but not limited to sirens, voice alerts, strobes, etc.).

For example, in some non-limiting aspects, the addressable device may be a fire alarm peripheral such as an activation or notification device. The fire alarm peripheral may include a base unit that is permanently installed on a wall or ceiling, and a device head which mounts onto the base unit. The addressing device in the base unit may be used for setting a unique address for the addressable device in a security/automation system that includes multiple addressable devices, so that each addressable device in the security/automation system may be uniquely and individually recognized and addressed. In one non-limiting aspect, for example, the security/automation system may include a loop of up to 250 fire alarm sensors/notification devices (e.g., a pair of wires may provide power and signal connectivity between a fire alarm control panel and up to 250 fire alarm peripherals), where each sensor/device is configured with a unique address. In one non-limiting aspect, for example, the addressable devices in the security/automation system may include emergency alarm system peripherals (such as hazard detectors, intrusion detectors, notification appliances, etc.) that each include a device head mounted onto a base unit that is permanently installed on a wall or ceiling. In these aspect, the addressing devices provided herein easily and efficiently assign an address to each of the emergency alarm system peripherals.

In one non-limiting aspect, for example, the addressing device may be implemented as an address pennant using a relatively small, inexpensive printed circuit board assembly (PCBA) that includes an integrated circuit (IC) with an electrically erasable reprogrammable read only memory (EEPROM). Once mounted onto the base unit, the addressing mechanism connects with metal contacts on the base unit, which connect to the fitted sensor head (e.g., using an existing “aux” port), such that the device head can electrically interface with and read the address pennant. The address pennant may be pre-programmed in production with the operating address field, e.g., pre-programmed to one of 250 possible addresses used for sensor heads. In an aspect, the 250 possible addresses, or a subset of them, may be packaged into smaller groups and shipped to installers. Accordingly, an installer may pick an address pennant with a desired address and slide the address pennant into a base unit. In some aspects, silkscreen printing may be implemented on the visible side of the address pennant, which may be the side of the address pennant that does not include surface mount devices (SMDs), to allow for visible indication of the pre-programmed address. Further, the address pennant may also be extended to allow for visible indication of the address on a flag protruding outside of the base unit. In these aspects, the address pennant may include drilled “mouse bites” to enable a user/installer to break off the extended portion if desired. For example, the address pennant may include small drilled holes/perforations to facilitate easy breakoff of the unwanted portion of the PCBA. In some aspects, the base unit may include a mechanical feature to retain the address pennant in the base unit once installed. For example, the address pennant may have an aperture such that the address pennant is locked into place using a flexible clip. Some existing systems may implement an addressing device in the device head. In these systems, when the device head is swapped/exchanged, the device address needs to be configured in the new device head. Unlike the aforementioned systems, the addressing device according to the present aspects is implemented in the base unit and stays with the base unit during replacement of the device head.

Some existing systems may implement a non-removable addressing device in the base unit of a device. In these systems, the base unit may be placed on a ceiling or high up on a wall, thus causing difficulty for an installer to change the address when necessary. Unlike the aforementioned systems, the present aspects allow for an installer to remove the addressing device from the base unit, swap or re-configure the addressing device, and then plug the swapped or re-configured addressing device back into the base unit that is located on a ceiling or high up on a wall.

Some existing systems implement an addressing device that requires a special physical tool and a conversion table to set the address. For example, some systems implement an addressing device in the base unit or in the device head, where the addressing device includes as array of binary dual in-line package (DIP) switches that can be configured using a special tool and a binary-to-decimal conversion table. However, the addressing device according to the present aspects includes a pre-programmable memory storing an address, therefore not requiring a physical tool/conversion table and not requiring field programming.

The present aspects provide a fully electronic addressing device that does not require another printed circuit board (PCB) functionality in the base unit. The addressing device according to some present aspects is backward/forward compatible with existing sensor heads and base units, such as, for example but not limited to, Generation 6 MX detector bases manufactured by TYCO Fire Protection Products and ZETTLER Fire Detection Products and Systems, detector bases manufactured by Simplex, Autocall, Fireclass, Vigilant, DBE, etc.

In some aspects, the addressing device may store other system information locally, such as the type of device head previously fitted, location information (e.g., point/zone string), the serial number of the base unit, etc.

In some aspects, the address field in the addressing device may be changeable/reconfigurable via the device head controlled by a control panel or by a special tool/device, if required.

Turning now to the figures, example aspects are depicted with reference to one or more components described herein, where components in dashed lines may be optional.

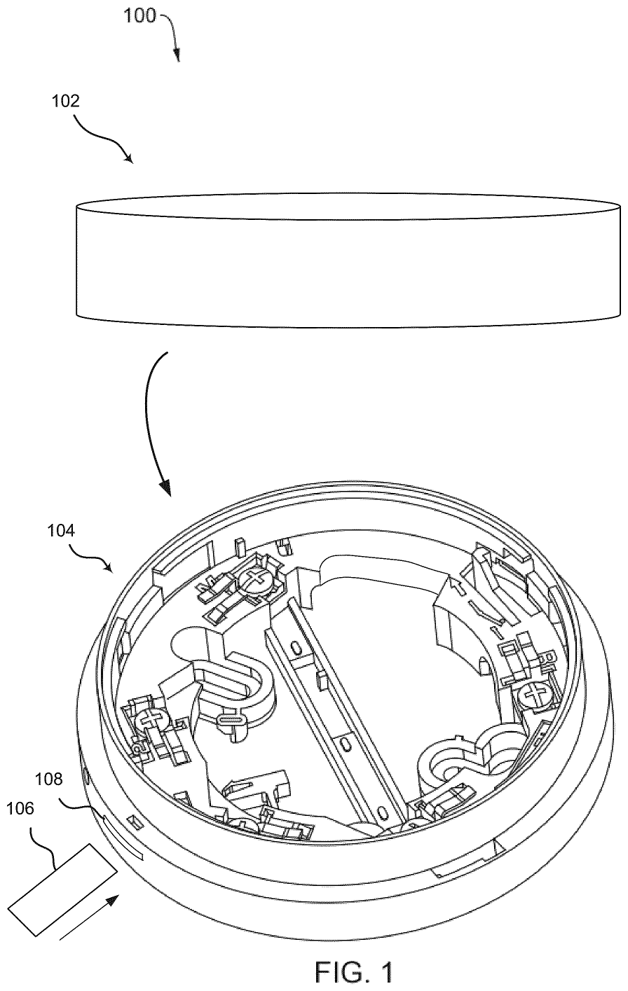

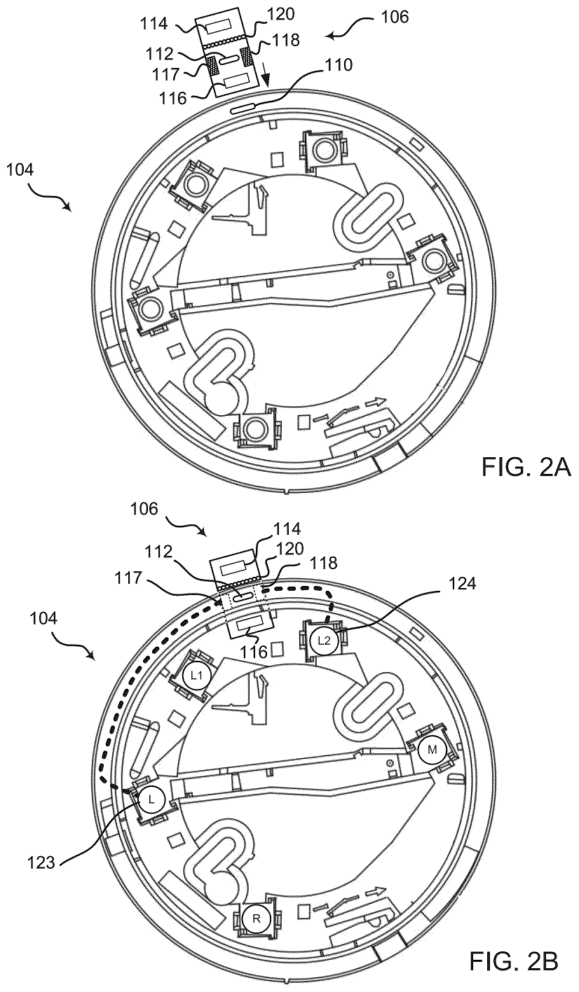

Referring to FIGS. 1, 2A, and 2B, an addressable device 100 includes a base unit 104 and a device head 102 removably mountable onto the base unit 104. The addressable device 100 may include, for example but not limited to, a sensor/detector unit or a notification unit in an emergency alarm system and/or a security/automation system. For example, the addressable device 100 may include an emergency alarm system peripheral such as a hazard detector (including but not limited to a smoke, heat, CO, CO2, flame, natural gas, or another toxic or noxious chemical detector, a pull station, etc.), an intrusion detector (including but not limited to window and door contacts, glass break sensors, water or water level sensors, passive IR detectors, cameras, sound sensors, motion detectors, etc.), or a notification appliance (including but not limited to sirens, voice alerts, strobes, etc.). The base unit 104 may be mounted on a wall or ceiling. The device head 102, which houses the actual sensor(s), notification transponder(s), etc., of the addressable device 100, is mounted onto the base unit 104 during installation or replacement of the addressable device 100.

While some aspects below may be directed to smoke detectors, the present aspects are not so limited and are applicable to other systems where addressable devices are fixed to building walls or ceiling or other structures, for example, but not limited to, notification appliances or other emergency detectors or annunciators, home automation devices, etc. In some aspects, the terms “device head,” “detector head,” and “sensor head” may refer to the transponder part of a notification appliance device that can attach to a base unit of the device.

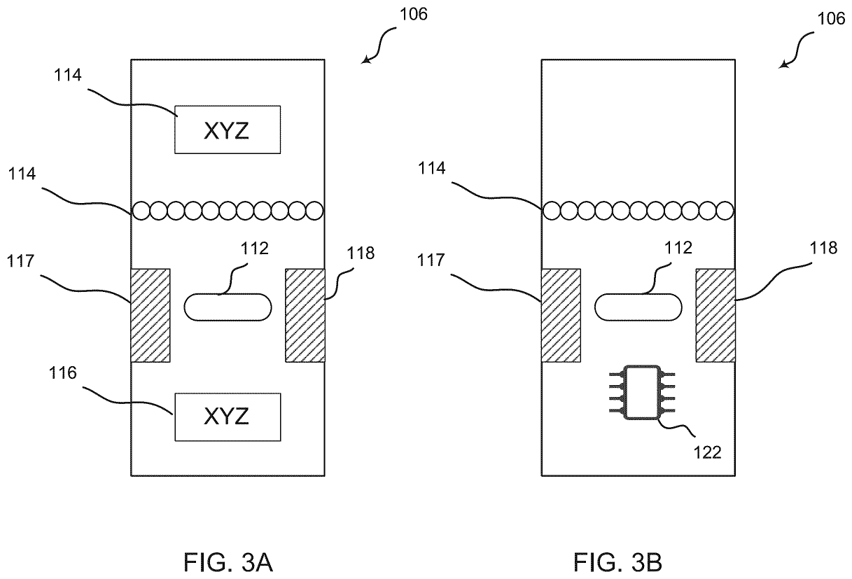

The base unit 104 of the addressable device 100 includes a removable addressing device 106 having the address of the addressable device 100 stored thereon. The address stored on the removable addressing device 106 in the base unit 104 is electrically readable by the device head 102. The removable addressing device 106 may be implemented as a removable address pennant, e.g., a card-shaped device which may also visually indicate the address on one or more labels printed thereon (see FIGS. 3A and 3B).

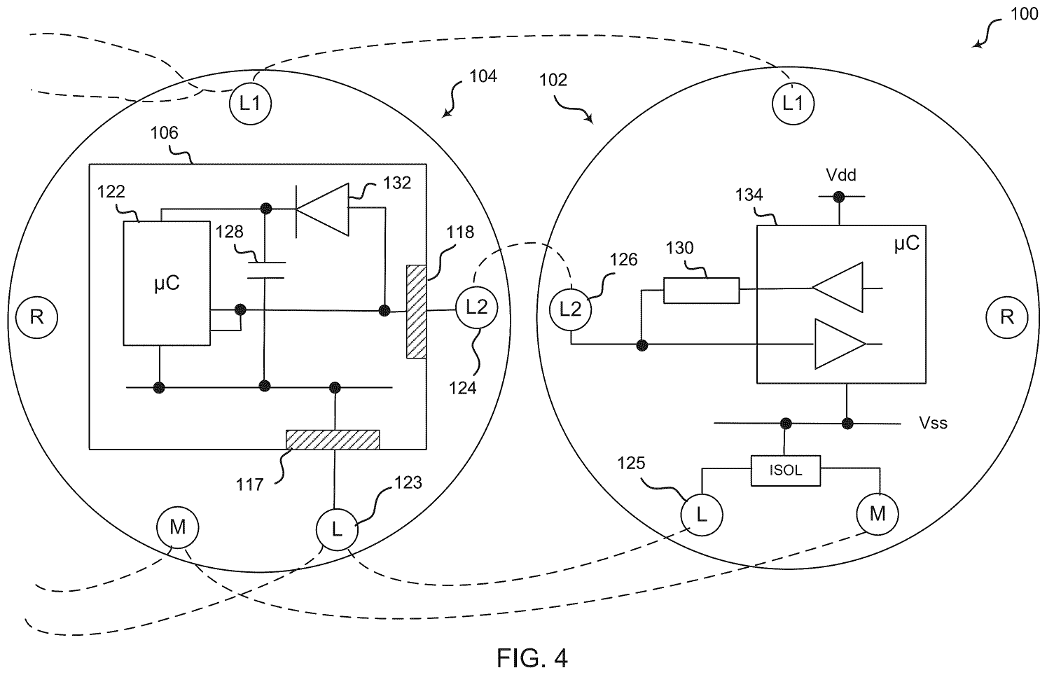

In one non-limiting aspect, for example, the device head 102 is align-able with the base unit 104 so that, when properly aligned, the device head 102 electronically connects with the removable addressing device 106 in the base unit 104 and reads the address stored on the removable addressing device 106 (further details are provided below with reference to FIG. 4). Since the addressing device 106 is removable from the base unit 104, an installer may change the address of the device 100 by swapping or reconfiguring the addressing device 106 and then inserting the swapped or re-configured addressing device 106 into the base unit 104.

In an aspect, the removable addressing device 106 is insertable into a receiving portion 108 (see FIG. 1) of the base unit 104 (where the receiving portion 108 may be a slot configured on an outer surface of the base unit 104 as in the example aspect of FIG. 1). In some aspects, once inserted, the removable addressing device 106 may lock into the base unit 104. For example, the base unit 104 may have a feature to hold and lock the removable addressing device 106 within the receiving portion 108 (e.g., a slot). Subsequent to insertion and locking, the removable addressing device 106 may later be removed by unclipping the feature with a simple tool (e.g., a screwdriver).

In an aspect, for example, the removable addressing device 106 may lock into the base unit 104 when a tab 110 (or latch) configured in the base unit 104 (see FIG. 2A) engages into a corresponding opening 112 configured in the removable addressing device 106 (see FIGS. 2A and 2B). Such locking may also improve the electrical connection of the removable addressing device 106 with the base unit 104 and the device head 102. Optionally, the base unit 104 may also include leaf spring electrical contacts that further help in holding the removable addressing device 106 in place.

The present aspects allow for a removable addressing device 106 such as a removable address pennant to be implemented as a common part that can be shipped to various job sites. Accordingly, the removable addressing device according to the present aspects provides a low cost addressing device which does not require assembly and can be quickly and readily replaced in the field with minimal complexity.

In some aspects, the value of the address stored on the removable addressing device 106 may be visibly indicated on a first label 116 and/or a second label 114 configured on a top surface of the removable addressing device 106 (see FIGS. 2A, 2B, and 3A, wherein in FIG. 3A the value of the address is indicated by the characters “XYZ” but it should be understood that any readable mechanism may be used to indicate the address, e.g., alphanumeric characters, numbers, colors, bar code, QR code, or any combination thereof). The first label 116 may be placed such that, when the removable addressing device 106 is mounted onto the base unit 104, the first label 116 is visible inside the base unit 104 (see FIG. 2B). The second label 114 may be placed such that, when the removable addressing device 106 is mounted onto the base unit 104, the second label 114 is visible outside the base unit 104 (see FIG. 2B). In some aspects, a portion of the removable addressing device 106 that includes the second label 114 may be breakable such that an installer may remove that portion by breaking along corresponding perforations 120 (e.g., mousebite drills, see FIGS. 2A, 2B, 3A, and 3B) configured in the removable addressing device 106.

In some aspects, the removable addressing device 106 includes a printed circuit board assembly (PCBA) that includes a memory 122 (see FIG. 3B) that stores the address of the device 100. In an aspect, the memory 122 may be a read only memory (ROM). In an aspect, the memory 122 may be an electrically erasable reprogrammable read only memory (EEPROM). In some aspects, the PCBA of the removable addressing device 106 may be protected against humidity via a coating layer, e.g., an epoxy-based, acrylics, etc. coating layer.

FIG. 4 is a schematic electrical wiring diagram of an aspect of the addressable device 100 in which the device head 102 and the base unit 104 have a matching set of power terminals, e.g., terminals “L,” “L1,” “L2,” “M,” and “R” as in Generation 6 MX systems. It should be noted that the illustrative arrangement/order of terminals “L,” “L1,” “L2,” “M,” and “R” in the base unit 104 in FIG. 4 does not match the physical arrangement/order of terminals “L,” “L1,” “L2,” “M,” and “R” illustrated in the top view of the base unit 104 in FIG. 2B. Instead, in FIG. 4, terminals “L,” “L1,” “L2,” “M,” and “R” in the base unit 104 are arranged in a way that improves the clarity of illustration of the electrical connections between the device head 102, the base unit 104, and the removable addressing device 106.

As described earlier, the device head 102 is align-able with the base unit 104 so that, when properly aligned, the device head 102 electronically connects with the removable addressing device 106 in the base unit 104 and reads the address stored on the removable addressing device 106. Referring to FIGS. 3A and 3B, the removable addressing device 106 may include a first contact 117 and a second contact 118 that provide electrical connection to the memory 122 for power-line communication. It should be noted that the first contact 117 and the second contact 118 may be provided on both surfaces of the removable addressing device 106 (on a top surface as in FIG. 3A and/or on a bottom surface as in FIG. 3B), so that the removable addressing device 106 may be inserted into the base unit 104 with either surface facing up.

Referring to FIG. 4, when the removable addressing device 106 is mounted onto the base unit 104, the first contact 117 and the second contact 118 of the removable addressing device 106 electrically connect with respective ones of a third contact 123 and a fourth contact 124 of the base unit 104. In an aspect, the third contact 123 and the fourth contact 124 may be the “L” and “L2” terminals of the base unit 104, respectively, and may be configured as leaf spring contacts. Further, when the device head 102 is mounted onto the base unit 104, the third contact 123 and the fourth contact 124 electrically connect with respective ones of a fifth contact 125 and a sixth contact 126 of the device head 102. In an aspect, the fifth contact 125 and the sixth contact 126 may be the “L” and “L2” terminals of the device head 102, respectively, and may be configured as leaf spring contacts. Accordingly, when the removable addressing device 106 and the device head 102 are mounted onto the base unit 104, the first contact 117 and the second contact 118 of the removable addressing device 106 are electrically connected with the fifth contact 125 and the sixth contact 126 of the device head 102, respectively.

Once connected, the “L” terminal is used as the master negative reference, while the “L2” terminal is used for data and voltage/power connection between the base unit 104 and the device head 102. More specifically, the device head 102 may use power-line communication over the “L2” terminal to read the address data stored on the memory 122. A capacitor 128 may be connected between the negative reference line and the power/data line of the memory 122 to hold up the voltage during the communications so that the memory 122 does not brown out (e.g., does not lose power). A diode 132 may be implemented between the second contact 118 and the memory 122 in the removable addressing device 106 in order to prevent rapid discharging of the capacitor 128 when a low-level logic signal is being transmitted (either from a microcontroller 134 in the device head 102 or from a microcontroller in the removable addressing device 106 (e.g., from the memory 122)). A resistor 130 may be implemented between the “L2” terminal and an output line of the microcontroller 134 in the device head 102 so that a microcontroller of the removable addressing device 106 (e.g., the memory 122) can override the control line in order to return data from the removable addressing device 106 to the device head 102.

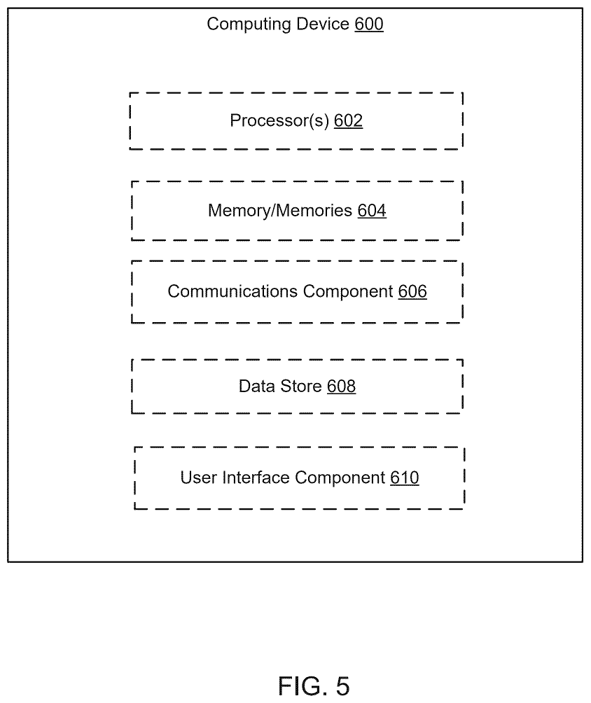

FIG. 5 illustrates an example block diagram providing details of computing components in a computing device 600 that may implement all or a portion of one or more components in an addressable device 100 or any other component described above. The computing device 600 may include one or more processors 602 which may be configured to execute or implement software, hardware, and/or firmware modules that perform any functionality described above with reference to one or more components in an addressable device.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 602 may include a micro-controller and/or may include a single or multiple set of processors or multi-core processors. Moreover, the one or more processors 602 may be implemented as an integrated processing system and/or a distributed processing system. The computing device 600 may further include one or more memories 604, such as for storing local versions of applications being executed by the one or more processors 602, related instructions, parameters, etc. The one or more memories 604 may include a type of memory usable by a computer, such as random access memory (RAM), read only memory (ROM), tapes, flash drives, magnetic discs, optical discs, volatile memory, non-volatile memory, and any combination thereof. Additionally, the one or more processors 602 and the one or more memories 604 may include and execute an operating system executing on the one or more processors 602, one or more applications, display drivers, etc., and/or other components of the computing device 600.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, In combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Further, the computing device 600 may include a communications component 606 that provides for establishing and maintaining communications with one or more other devices, parties, entities, etc., utilizing hardware, software, and services. The communications component 606 may carry communications between components on the computing device 600, as well as between the computing device 600 and external devices, such as devices located across a communications network and/or devices serially or locally connected to the computing device 600. For example, the communications component 606 may include one or more buses, and may further include transmit chain components and receive chain components associated with a wireless or wired transmitter and receiver, respectively, operable for interfacing with external devices.

In some optional aspects, the computing device 600 may additionally include a data store 608, which can be any suitable combination of hardware and/or software, that provides for mass storage of information, databases, and programs. For example, the data store 608 may be or may include a data repository for applications and/or related parameters not currently being executed by the one or more processors 602. In addition, the data store 608 may be a data repository for an operating system, application, display driver, etc., executing on the one or more processors 602, and/or one or more other components of the computing device 600.

Also, in some optional aspects, the computing device 600 may additionally include a user interface component 610 operable to receive inputs from a user of the computing device 600 and further operable to generate outputs for presentation to the user (e.g., via a display interface to a display device). The user interface component 610 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 610 may include one or more output devices, including but not limited to a display interface, a speaker, a haptic feedback mechanism, a printer, any other mechanism capable of presenting an output to a user, or any combination thereof.

Some further example aspects of the devices described herein are provided in the following clauses.

1. An addressable device, comprising:
a base unit mountable on a structure;
a device head removably mountable onto the base unit;
wherein a removable addressing device is removably mountable onto the base unit and comprises at least one memory storing an address for the addressable device; and
wherein, when the device head and the removable addressing device are mounted onto the base unit, the device head is electrically connected to the removable addressing device and is configured to read the address stored on the at least one memory of the removable addressing device.

2. The addressable device of clause 1, wherein the removable addressing device comprises a printed circuit board assembly (PCBA) comprising the at least one memory.

3. The addressable device of clause 1 or 2, wherein the at least one memory comprises a read only memory (ROM).

4. The addressable device of any one of the above clauses, wherein the at least one memory comprises an electrically erasable reprogrammable read only memory (EEPROM).

5. The addressable device of any one of the above clauses, wherein the removable addressing device comprises an address pennant having a first surface and a second surface, wherein, when the removable addressing device is mounted onto the base unit, at least a first portion of the first surface is visible inside the base unit.

6. The addressable device of clause 5, wherein the address is visibly indicated on the portion of the first surface of the address pennant.

7. The addressable device of clause 5 or 6, wherein the base unit comprises a slot configured for insertion of the address pennant thereinto.

8. The addressable device of clause 7, wherein the base unit comprises a receiving member configured for engaging with an engagement member of the address pennant when the address pennant is inserted into the slot.

9. The addressable device of clause 8, wherein the receiving member comprises an aperture, wherein the engagement member comprises a tab member or a clip member configured on the first surface of the address pennant.

10. The addressable device of any one of clauses 5 to 9, wherein the address pennant comprises first electrical contacts configured on the first surface and/or on the second surface, wherein the first electrical contacts are electrically connected to the at least one memory of the address pennant.

11. The addressable device of clause 10, wherein, when the removable addressing device is mounted onto the base unit, the first electrical contacts are electrically connected to second electrical contacts configured on the base unit.

12. The addressable device of clause 10 or 11, wherein, when the device head and the removable addressing device are mounted onto the base unit, the first electrical contacts are electrically connected to the second electrical contacts configured on the base unit, and the second electrical contacts are electrically connected to third electrical contacts configured on the device head.

13. The addressable device of clause 12, wherein the third electrical contacts are electrically connected to an auxiliary port in the device head.

14. The addressable device of any one of clauses 5 to 13, wherein, when the device head and the removable addressing device are mounted onto the base unit, the address stored on the at least one memory of the address pennant is re-configurable by remotely controlling the device head.

15. The addressable device of any one of clauses 5 to 14, wherein, when the removable addressing device is mounted onto the base unit, at least a second portion of the first surface is visible outside the base unit, wherein the address is visibly indicated on the first portion and/or on the second portion of the first surface of the address pennant.

16. The addressable device of clause 15, wherein the second portion is breakable from the address pennant.

17. The addressable device of any one of the above clauses, wherein, when the device head and the removable addressing device are mounted onto the base unit, the device head is electrically connected to the removable addressing device via a first electrical path and a second electrical path.

18. The addressable device of clause 17, wherein the first electrical path is connected to a ground voltage line of the base unit and the device head, wherein the device head is configured to read the address stored on the at least one memory of the removable addressing device over the second electrical path using power-line communication.

19. A removable addressing device comprising:
at least one memory storing an address for an addressable device;
wherein the removable addressing device is removably mountable onto a base unit of the addressable device;
wherein the base unit is mountable on a structure;
wherein the addressable device further comprises a device head that is removably mountable onto the base unit; and
wherein, when the device head and the removable addressing device are mounted onto the base unit, the device head is electrically connected to the removable addressing device and is configured to read the address stored on the at least one memory of the removable addressing device.

20. A base unit of an addressable device, comprising:
a receiving portion configured for removably mounting a removable addressing device thereonto;
wherein the removable addressing device comprises at least one memory storing an address for the addressable device;
wherein the base unit is mountable on a structure;
wherein a device head of the addressable device is removably mountable onto the base unit; and
wherein, when the device head and the removable addressing device are mounted onto the base unit, the device head is electrically connected to the removable addressing device and is configured to read the address stored on the at least one memory of the removable addressing device.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An addressable device, comprising:
a base unit mountable on a structure;
a device head removably mountable onto the base unit;
wherein a removable addressing device is removably mountable onto the base unit and comprises at least one memory storing an address for the addressable device; and
wherein, when the device head and the removable addressing device are mounted onto the base unit, the device head is electrically connected to the removable addressing device and is configured to read the address stored on the at least one memory of the removable addressing device.

2. The addressable device of claim 1, wherein the removable addressing device comprises a printed circuit board assembly (PCBA) comprising the at least one memory.

3. The addressable device of claim 1, wherein the at least one memory comprises a read only memory (ROM).

4. The addressable device of claim 1, wherein the at least one memory comprises an electrically erasable reprogrammable read only memory (EEPROM).

5. The addressable device of claim 1, wherein the removable addressing device comprises an address pennant having a first surface and a second surface, wherein, when the removable addressing device is mounted onto the base unit, at least a first portion of the first surface is visible inside the base unit.

6. The addressable device of claim 5, wherein the address is visibly indicated on the portion of the first surface of the address pennant.

7. The addressable device of claim 5, wherein the base unit comprises a slot configured for insertion of the address pennant thereinto.

8. The addressable device of claim 7, wherein the base unit comprises a receiving member configured for engaging with an engagement member of the address pennant when the address pennant is inserted into the slot.

9. The addressable device of claim 8, wherein the receiving member comprises an aperture, wherein the engagement member comprises a tab member or a clip member configured on the first surface of the address pennant.

10. The addressable device of claim 5, wherein the address pennant comprises first electrical contacts configured on the first surface and/or on the second surface, wherein the first electrical contacts are electrically connected to the at least one memory of the address pennant.

11. The addressable device of claim 10, wherein, when the removable addressing device is mounted onto the base unit, the first electrical contacts are electrically connected to second electrical contacts configured on the base unit.

12. The addressable device of claim 10, wherein, when the device head and the removable addressing device are mounted onto the base unit, the first electrical contacts are electrically connected to second electrical contacts configured on the base unit, and the second electrical contacts are electrically connected to third electrical contacts configured on the device head.

13. The addressable device of claim 12, wherein the third electrical contacts are electrically connected to an auxiliary port in the device head.

14. The addressable device of claim 5, wherein, when the device head and the removable addressing device are mounted onto the base unit, the address stored on the at least one memory of the address pennant is re-configurable by remotely controlling the device head.

15. The addressable device of claim 5, wherein, when the removable addressing device is mounted onto the base unit, at least a second portion of the first surface is visible outside the base unit, wherein the address is visibly indicated on the first portion and/or on the second portion of the first surface of the address pennant.

16. The addressable device of claim 15, wherein the second portion is breakable from the address pennant.

17. The addressable device of claim 1, wherein, when the device head and the removable addressing device are mounted onto the base unit, the device head is electrically connected to the removable addressing device via a first electrical path and a second electrical path.

18. The addressable device of claim 17, wherein the first electrical path is connected to a ground voltage line of the base unit and the device head, wherein the device head is configured to read the address stored on the at least one memory of the removable addressing device over the second electrical path using power-line communication.

19. A removable addressing device, comprising:
at least one memory storing an address for an addressable device;
wherein the removable addressing device is removably mountable onto a base unit of the addressable device;
wherein the base unit is mountable on a structure;
wherein the addressable device further comprises a device head that is removably mountable onto the base unit; and
wherein, when the device head and the removable addressing device are mounted onto the base unit, the device head is electrically connected to the removable addressing device and is configured to read the address stored on the at least one memory of the removable addressing device.

20. A base unit of an addressable device, comprising:
a receiving portion configured for removably mounting a removable addressing device thereonto;
wherein the removable addressing device comprises at least one memory storing an address for the addressable device;
wherein the base unit is mountable on a structure;
wherein a device head of the addressable device is removably mountable onto the base unit; and
wherein, when the device head and the removable addressing device are mounted onto the base unit, the device head is electrically connected to the removable addressing device and is configured to read the address stored on the at least one memory of the removable addressing device.
